(19) United States
(12) Patent Application Publication
(10) Pub. No.: US 2017/0233939 A1
(43) Pub. Date: Aug. 17, 2017

(54) LIQUID ADDITIVE SUPPLY DEVICE FOR WASHING MACHINE

(71) Applicant: Dongbu Daewoo Electronics Corporation, Seoul (KR)

(72) Inventor: Jong Jin LEE, Seoul (KR)

(21) Appl. No.: 15/287,519

(22) Filed: Oct. 6, 2016

(30) Foreign Application Priority Data
Feb. 16, 2016 (KR) 10-2016-0017617

(51) Int. Cl. D06F 39/10; B01D 29/56; D06F 39/14; B01D 35/027; D06F 39/02; D06F 39/08

(52) U.S. Cl. CPC D06F 39/10; D06F 39/022; D06F 39/088; D06F 39/14; B01D 35/027; B01D 29/56; B01D 2201/0415

(57) ABSTRACT

A liquid additive supply device for a washing machine that can be removably accommodated in an accommodation part of a detergent dispenser. The liquid additive supply device includes a storage part for storing a liquid additive to be supplied to a detergent dispenser during a wash cycle. A filter is installed inside the storage part for filtering extraneous material.

### CROSS-REFERENCE TO RELATED APPLICATIONS

This application is based on and claims priority from Korean Patent Application No. 10-2016-0017617, filed on Feb. 16, 2016, the disclosure of which is incorporated by reference herein in its entirety for all purposes.

### TECHNICAL FIELD

The present disclosure relates to washing machines, and more particularly, to liquid additive supply devices for washing machines.

### BACKGROUND OF THE INVENTION

In general, detergent is added to washing machines and dispensed for washing laundry during washing cycles. A washing machine typically uses a detergent dispenser to supply and dispense detergent to the washing machine. The detergent dispenser may have a drawer-type detergent supply device. A user can pull out the detergent supply device partially to add detergent.

Extraneous material such as dust or the like is often introduced into the detergent supply device together with the detergent, causing detergent residue to build up in the detergent supply device. Especially after a long period of non-use, this residue tends to become stuck in the detergent supply device. In a conventional detergent dispenser, the detergent supply device is not designed to be detached from the detergent dispenser by a user, making it difficult to clean the detergent residue at the bottom of the detergent supply device.

### PRIOR ART DOCUMENTS

### [Patent Documents]

Patent Document 1: Korean Patent Application Publication No. 10-2010-0042985 (published on Apr. 27, 2010)

### SUMMARY OF THE INVENTION

Embodiments of the present disclosure provide a liquid additive supply device that can be easily removed from, and attached back to, the detergent dispenser on a washing machine by a user. Thereby, a user can advantageously clean the liquid additive supply device conveniently.

According to embodiments of the present disclosure, a liquid additive supply device for a washing machine includes: a main body; a liquid detergent storage part configured to store a liquid detergent; a fabric softener storage part configured to store a fabric softener; a nozzle part configured to move the liquid detergent stored in the liquid detergent storage part and the fabric softener stored in the fabric softener storage part upward from a lower portion of the main body to an upper portion of the main body; a first filter removably mounted inside the liquid detergent storage part and configured to filter extraneous material introduced from the outside into the liquid detergent storage part; and a second filter removably mounted inside the fabric softener storage part and configured to filter extraneous material introduced from the outside into the fabric softener storage part.

A pair of guide ribs may be formed at one side of the main body and has a gap growing larger away from a bottom surface of the main body. The guided ribs are configured to guide movement of the first filter and the second filter when they are mounted in the storage parts or removed therefrom.

Each of the first filter and the second filter may be disposed between a front region of the main body where the liquid detergent and the fabric softener are supplied and a rear region of the main body where the nozzle part is disposed.

According to embodiments of the present disclosure, it is possible to provide a liquid additive supply device for a washing machine, which is capable of being removably accommodated in an accommodation part of a detergent dispenser and capable of being easily cleaned.

### BRIEF DESCRIPTION OF THE DRAWINGS

FIG. 1 illustrates a perspective view of an exemplary washing machine according to one embodiment of the present disclosure.

FIG. 2 illustrates an assembled perspective view of an exemplary liquid additive supply device for a washing machine according to one embodiment of the present disclosure.

FIG. 3 illustrates an exploded perspective view of the exemplary liquid additive supply device for a washing machine according to one embodiment of the present disclosure.

FIG. 4A illustrates a perspective view of an exemplary cover part of the liquid additive supply device for a washing machine according to one embodiment of the present disclosure.

FIG. 4B is a sectional view taken along line A-A′ in FIG. 4A.

FIG. 5 illustrates a perspective view of an exemplary filter of the liquid additive supply device for a washing machine according to one embodiment of the present disclosure.

FIG. 6 illustrates a front view of the exemplary filter of the liquid additive supply device for a washing machine according to one embodiment of the present disclosure.

FIG. 7 illustrates a state in which a filter is installed inside a main body of the liquid additive supply device for a washing machine according to one embodiment of the present disclosure.

FIG. 8 illustrates a state in which the filter is being removed from the main body of the liquid additive supply device for a washing machine according to one embodiment of the present disclosure.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

One or more exemplary embodiments of the present disclosure will be described more fully hereinafter with reference to the accompanying drawings, in which one or more exemplary embodiments of the disclosure can be easily determined by those skilled in the art. As those skilled in the art will realize, the described exemplary embodiments may be modified in various different ways, all without departing from the spirit or scope of the present disclosure, which is not limited to the exemplary embodiments described herein.

It is noted that the drawings are schematic and are not necessarily dimensionally illustrated. Relative sizes and proportions of parts in the drawings may be exaggerated or reduced in their sizes, and a predetermined size is just exemplificative and not limitative. The same reference numerals designate the same structures, elements, or parts illustrated in two or more drawings in order to exhibit similar characteristics.

The exemplary embodiments of the present disclosure illustrate are described herein. Various modifications of the drawings are expected. Accordingly, the exemplary embodiments are not limited to a specific form of the illustrated region, but for example, can include modifications of forms for manufacturing.

The configuration and operation according to one embodiment of the present disclosure will now be described in detail with reference to the accompanying drawings.

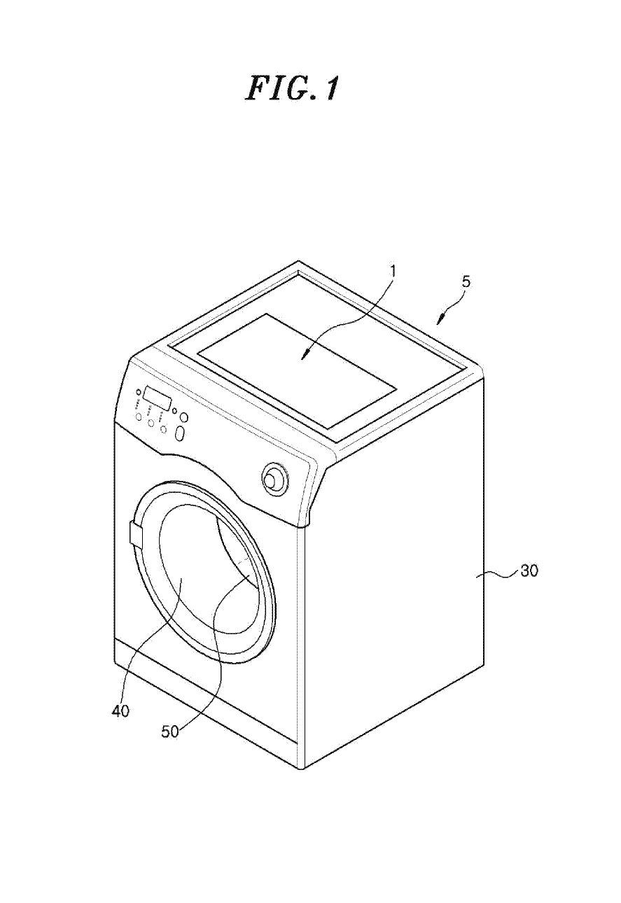

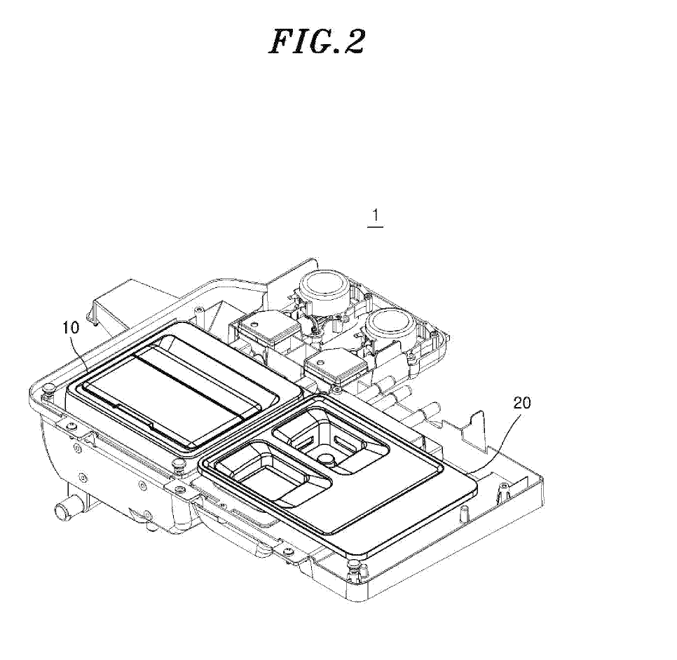

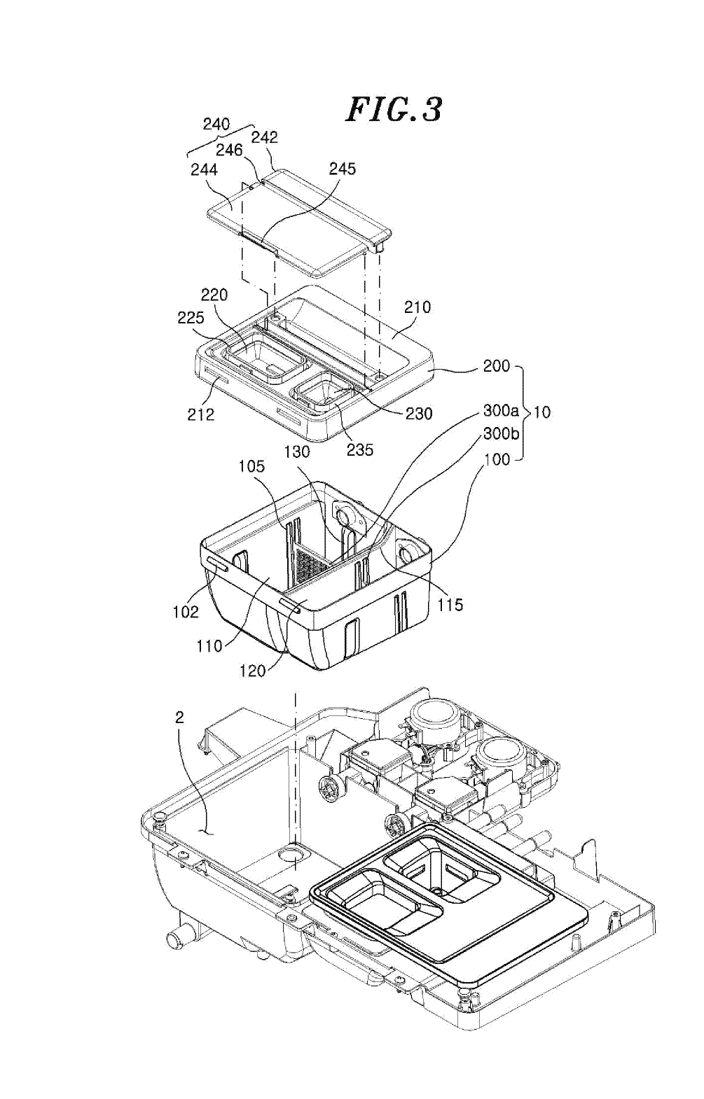

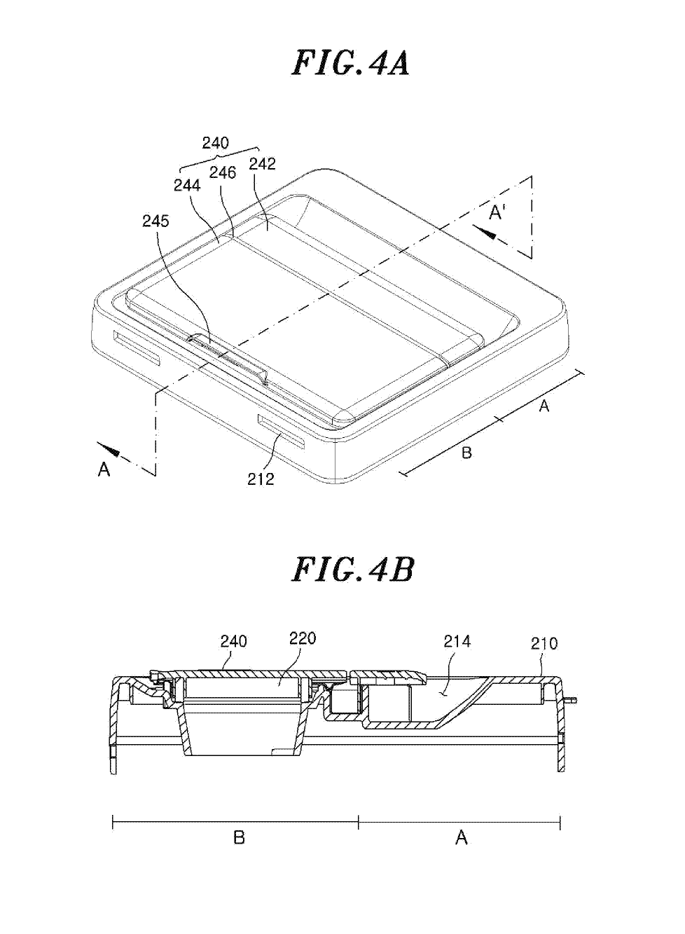

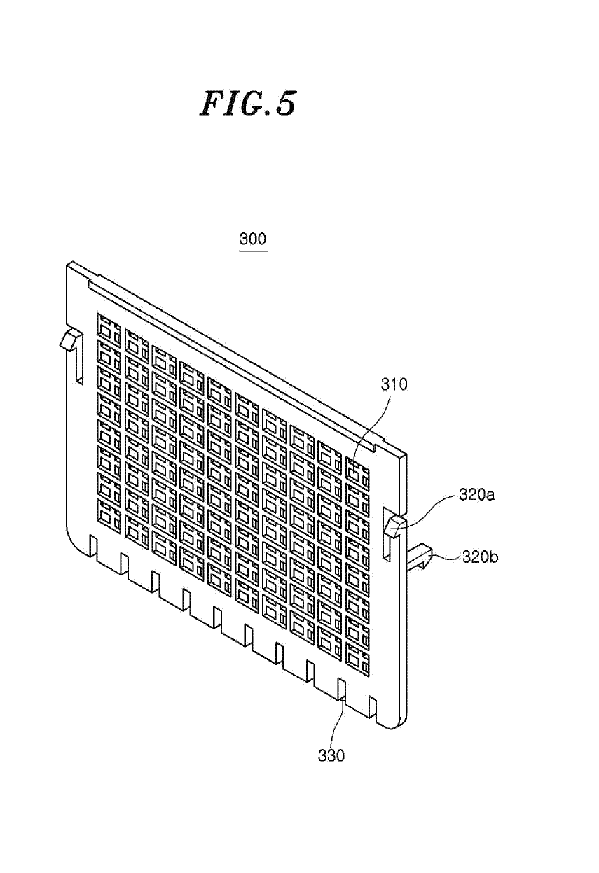

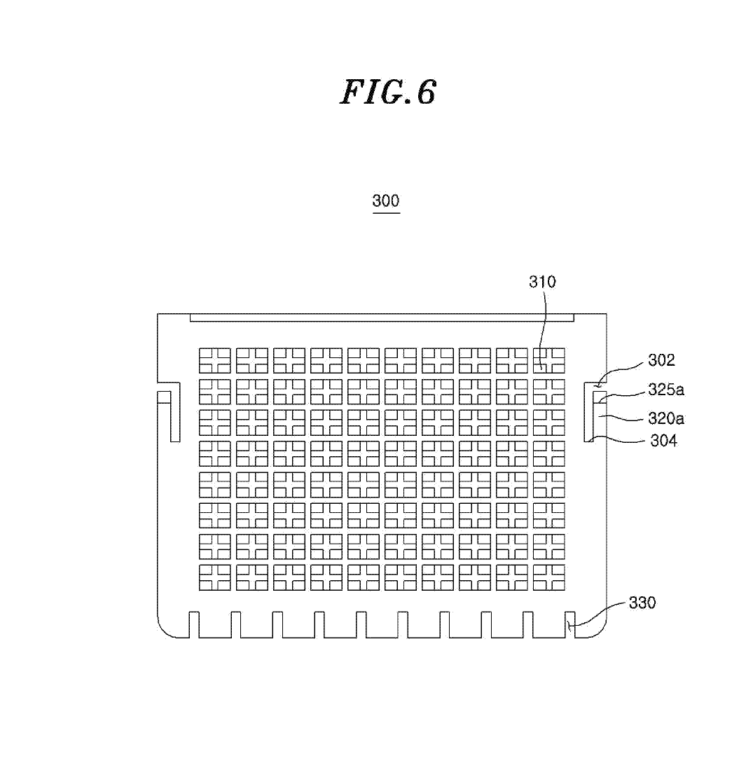

FIG. 1 illustrates a perspective view of an exemplary washing machine according to one embodiment of the present disclosure. FIG. 2 illustrates an assembled perspective view of an exemplary liquid additive supply device for a washing machine according to one embodiment of the present disclosure. FIG. 3 illustrates an exploded perspective view of the exemplary liquid additive supply device for a washing machine according to one embodiment of the present disclosure. FIG. 4A illustrates a perspective view of an exemplary cover part of the liquid additive supply device for a washing machine according to one embodiment of the present disclosure. FIG. 4B is a sectional view taken along line A-A′ in FIG. 4A. FIG. 5 illustrates a perspective view of an exemplary filter of the liquid additive supply device for a washing machine according to one embodiment of the present disclosure. FIG. 6 illustrates a front view of the exemplary filter of the liquid additive supply device for a washing machine according to one embodiment of the present disclosure.

Referring to FIG. 1, the exemplary washing machine 5 includes a cabinet 30, a tub 40, a drum 50 and a detergent dispenser 1. The washing machine 5 may be a drum type washing machine having a rotatable drum 50. However, the washing machine 5 is not limited to any specific type.

The cabinet 30 includes an exterior housing of the washing machine 5. The tub 40, the drum 50 and the like may be installed within the cabinet 30. The detergent dispenser 1 may be assembled at the top of the cabinet 30.

In addition to the tub 40, the drum 50 and the detergent dispenser 1, various other components of different functions may be enclosed in the cabinet 30. For example, in the cabinet 30, there may be installed a detergent supply pipe (not shown) configured to couple the detergent dispenser 1 to the tub 40, so that the detergent contained in the detergent dispenser 1 can be carried and dispensed to the tub 40. An electric motor may be configured to provide power to the drum 50. A water supply device (not shown) may be used to supply washing water into the tub 40. A drying device (not shown) may be used to dry the objects (e.g., laundry) inside the tub 40. A drain device (not shown) may be configured to drain the washing water outside the cabinet 30.

The tub 40 has a cylindrical structure used to accommodate washing water. It is horizontally positioned within the cabinet 30. The tub 40 may receive detergent from the detergent dispenser 1, and may receive washing water from the water supply device. Washing water can be drained from the tub 40 to the outside of the cabinet 30 through the drain device.

The drum 50 may be rotatably installed inside the tub 40 and coupled to a motor. The drum 50 can contain laundry or other washing objects during operation. The laundry is stirred with the rotation of the drum 50 and washed with the washing water and detergent supplied into the tub 40.

The detergent dispenser 1 may include a liquid additive supply device 10 removably accommodated within an accommodation part 2 inside the detergent dispenser 1 and a preliminary additive supply device 20 integrally formed with the detergent dispenser 1.

Referring to FIGS. 2 to 6, the liquid additive supply device 10 according to one embodiment of the present disclosure includes an accommodation part 2 formed in the detergent dispenser 1, a main body 100 removably accommodated within the accommodation part 2 and configured to store a liquid additive, a cover part 200 configured to selectively cover the top opening of the main body 100, and a filter 300 removably mounted inside the main body 100 and configured to filter out extraneous material that enter the main body 100 from outside.

The liquid additive supply device 10 can be used to contain a liquid additive (e.g., liquid detergent or fabric softener) to be supplied to the tub 40 during a washing cycle. Furthermore, the preliminary additive supply device can contain another additive, for example preliminary additive (e.g., powdery detergent or preliminary fabric softener,) to be supplied to the tub 40 during a washing cycle. A preliminary additive may be used when the liquid additive supply device 10 is separated from the accommodation part 2 of the detergent dispenser 1.

Since the detergent dispenser 1 extends along the width of the cabinet 30 (e.g., the left-right direction of the cabinet 30 when the washing machine is positioned for operation) at the top of the cabinet 30, the liquid additive supply device 10 and the preliminary additive supply device 20 have relatively large capacities for a liquid additive and a preliminary additive.

Hereinafter, descriptions will be made primarily on the liquid additive supply device 10 configured to store one or more liquid additives such as liquid detergent and fabric softener. The liquid additive supply device 10 is removably accommodated within the accommodation part 2 of the detergent dispenser 1.

The main body 100 may include two storages parts, for example a first storage part 110 for containing a first additive (e.g., liquid detergent), and a second storage part 120 for containing a second additive (e.g., fabric softener for example). Hereinafter embodiments are described using a liquid detergent storage part 110 and a fabric softener storage part 120 as an example, but the present disclosure is not limited to any specific type of additives that can be added in the storages parts 110 and 120.

In this case, the bottom wall of the main body 100 may be downwardly inclined from a front region (where the liquid additives are supplied) toward a rear region where the nozzle 130 is positioned. In this way, the liquid additives can flow under gravity in the main body 100, which prevents the liquid additives from sticking to the lower portion of the main body 100 as would occur if the liquid additives remain static.

The liquid detergent storage part 110 and the fabric softener storage part 120 may be partitioned by a partition wall 115. Thus, the liquid detergent stored in the liquid detergent storage part 110 and the fabric softener stored in the fabric softener storage part 120 may be used as main liquid detergent and main fabric softener, respectively.

Liquid detergent or any other suitable liquid additive may be stored in the liquid detergent storage part 110. A large supply of liquid detergent useful for multiple washing operations may be stored in the liquid detergent storage part 110.

Fabric softener or any other suitable liquid additive can be stored in the fabric softener storage part 120. A large supply of fabric softener useful for multiple washing operations may be stored in the fabric softener storage part 120.

In general, a larger amount of liquid detergent is used than fabric softener during washing. Thus, the height of the liquid detergent storage part 110 may be configured larger than the height of the fabric softener storage part 120. In other words, the liquid detergent storage part 110 may be larger than the fabric softener storage part 120. However, this discussion is nothing more than one example and may be modified without departing from the scope of the present disclosure.

On the sidewall of the main body 100, a pair of guide ribs 105 extending in the longitudinal direction of the main body 100 are used to guide the filter 300. Herein, “the longitudinal direction of the main body 100” refers to the up-down (vertical) direction of the main body 100 when the washing machine is positioned for operation. In addition, the guide ribs 105 may also be formed on the partition wall 115.

The main body 100 and the guide ribs 105 may be injection-molded as one piece, e.g., substantially at the same time. However, this implementation is merely exemplary. The guide ribs 105 may be manufactured as a separate component and then integrated with the main body 100. The structure of the guide ribs 105 is described below together with the filter 300.

The nozzle part 130 may receive liquid detergent from the liquid detergent storage part 110 and receive the fabric softener from the fabric softener storage part 120. The nozzle part 130 may be coupled to a suction pump (not shown). During a washing operation, liquid detergent and the fabric softener can be carried from the lower portion of the main body 100 to the upper portion thereof through the nozzle part 130 and then dispensed into the tub 40. In other words, the liquid detergent and the fabric softener are transported from the bottom to the top the main body 100 via the nozzle part 130. Thus, even if the main body 100 is separated from the accommodation part 2 of the detergent dispenser 1, the liquid detergent and the fabric softener contained in the main body 100 would not flow outward.

The cover part 200 can cover the upper portion of the main body 100. The cover part 200 may include: a main cover 210 provided with a knob portion having a knob groove 214 and a detergent supply portion for supplying the liquid additives; a liquid detergent supply hole 220 in the detergent supply portion of the main cover 210 and configured to supply the liquid detergent; a fabric softener supply hole 230 in the detergent supply portion of the main cover 210 which is configured to supply the fabric softener; and an auxiliary cover 240 coupled to the main cover 210 and configured to open or close the liquid detergent supply hole 220 and the fabric softener supply hole 230. The fabric softener supply hole 230 is spaced apart from the liquid detergent supply hole 220.

The main cover 210 may be the main body of the cover part 200. A knob groove 214 is formed in the knob portion A of the main cover 210 (see FIG. 4B). A user can put a hand in the knob groove 214 to lift up the liquid additive supply device 10, thereby removing it from the accommodation part 2 of the detergent dispenser 1.

A locking slot 212 may be formed on at least one side surface of the main cover 210. A locking tab 102 formed on at least on one outer surface of the main body 100 can be inserted (e.g., snapped) into the locking slot 212. As the locking tab 102 of the main body 100 and the locking slot 212 of the main cover 210 are coupled together, the main body 100 and the main cover 210 may be securely coupled to each other.

The liquid detergent supply hole 220 is covered by the auxiliary cover 240. Liquid detergent can be added through the liquid detergent supply hole 220 and stored in the liquid detergent storage part 110. A first gasket 225 is disposed along the outer circumferential surface of the liquid detergent supply hole 220 to seal the gap between the auxiliary cover 240 and the liquid detergent supply hole 220. This can prevent liquid detergent from overflowing from the liquid detergent supply hole 220.

The fabric softener supply hole 230 is covered by the auxiliary cover 240. Fabric softener can be added through the fabric softener supply hole 230 and stored in the fabric softener storage part 120. A second gasket 235 is formed along the outer circumferential surface of the fabric softener supply hole 230 to seal the gap between the auxiliary cover 240 and the fabric softener supply hole 230. This can prevent fabric softener from overflowing from the fabric softener supply hole 230.

The auxiliary cover 240 may include a fixed portion 242 coupled to one side of the knob portion A of the main cover 210, a rotatable portion 244 coupled to an edge of the fixed portion 242 and can be rotatably coupled to the main cover 210. A folding portion 246 is disposed between the fixed portion 242 and the rotatable portion 244.

The fixed portion 242 may be threadedly coupled to one side of the knob portion A. Thus, even if the auxiliary cover 240 is periodically opened and closed by a user, the auxiliary cover 240 is barely separated from the main cover 210. This may extends the lifespan of the auxiliary cover 240.

The rotatable portion 244 may extend from the fixed portion 242 and integrally formed with the fixed portion 242. Alternatively, the rotatable portion 244 may be manufactured as a separate part and integrated with the fixed portion 242 through the folding portion 246. A protrusion portion 245 can be used by a user to lift up the rotatable portion 244 and may be disposed at the free end of the rotatable portion 244.

The folding portion 246 may be injection-molded in a thickness smaller than the thickness of the fixed portion 242 and the rotatable portion 244. Thus, the folding portion 246 can be folded more easily than the fixed portion 242 and the rotatable portion 244. In other words, the rotatable portion 244 of the auxiliary cover 240 is rotatable about the folding portion 246. When the rotatable portion 244 rotates (or pivots), the liquid detergent supply hole 220 and the fabric softener supply hole 230 may be exposed to a user. However, this discussion is nothing more than one example. The folding portion 246 may be coupled with a separate hinge shaft (not shown) and may be folded through the hinge shaft.

The filter 300 may be removably mounted inside the main body 100 and used to filter out extraneous material. The term “extraneous material” used herein refers to dust or the like introduced together with the liquid additives supplied through the auxiliary cover 240.

More specifically, the filter 300 may include a first filter 300a positioned between a front region of the main body 100 where liquid detergent is supplied and a rear region of the main body 100 where the nozzle part 130 is disposed. The filter 300 may also include a second filter 300b positioned between a front region of the main body 100 where fabric softener is supplied and a rear region of the main body 100 where the nozzle part 130 is disposed. The filter 300 may have a mesh structure with mesh holes 310.

The mesh holes 310 for instance have a horizontal size of about 3 mm and a vertical size of about 1.5 mm.

More specifically, the filter 300 may be inserted in the guide ribs 105 that are disposed on the side of the main body 100. The filter can slide up-down along the guide ribs 105. The gap between the guide ribs 105 may become increasingly larger from the bottom to the top of the main body 100. In this configuration, the filter 300 can be easily inserted into and removed from the guide ribs 105. When the filter 300 is mounted inside the main body 100, the lower end of the filter 300 may be positioned in a region between the guided ribs 105 having a relatively small clearance, while the upper end of the filter 300 is positioned in a region having a relatively large clearance.

As the lower end of the filter 300 is positioned in the small clearance, it can be stably supported between the guide ribs 105. The upper end of the filter 300 is positioned in the large clearance between the guide ribs 105.

This facilitates a user to hold the upper end of the filter 300 and easily remove it from the guide ribs 105.

Furthermore, if extraneous material accumulates on the filter 300, a user may advantageously remove the filter 300 from the guide ribs 105 to clean up.

A first locking tab 320a may be formed on the edge and along a surface of the filter 300 and can be inserted into the guide ribs 105. A slot 302 may be formed on a side edge of the filter 300. The first locking tab 320a may be formed at the end of the slot 302 and extend along the slot 302 (as shown in FIG. 5.) A first insertion tab 325a may be formed at the free end of the first locking tab 320a.

A second locking tab 320b may be formed to protrude from one surface in a substantially perpendicular angle on the side of the filter 300 (see FIG. 5.) Thus, the second locking tab and the first locking tab extend in perpendicular orientations relative to each other. For example, the second locking tab 320b may be formed below where the slot 302 is formed. A second insertion tab 325b may be formed to protrude toward the opposite surface of one surface of the filter 300 on which the second locking tab 320b is formed.

A first locking groove (not shown) capable of coupling with the first insertion tab 325a of the first locking tab 320a may be formed in one of the guide ribs 105. A second locking groove (not shown) for coupling to the second insertion tab 325b may be formed in one of the guide ribs 105. This enables the filter 300 to be securely installed between the guide ribs 105.

In one embodiment, the height of the filter 300 may be set smaller than the height of the guide ribs 105 so that a user can remove the filter 300 from the guide ribs 105 conveniently. In another embodiment, the height of the filter 300 may be set equal to or larger than the height of the guide ribs 105. In this case, the upper end of the filter 300 may make direct contact with the lower end of the main cover 210. The direct contact prevents extraneous material from by-passing the filter 300. An engaging rib (not shown) may be formed in the main cover 210 for maintaining the contact between the filter 300 and the main cover 210.

To prevent overflow of the liquid detergent and the fabric softener, a user may add the liquid detergent into the liquid detergent storage part 110 as to not exceed the height of the liquid detergent storage part 110 and may supply the fabric softener into the fabric softener storage part 120 as to not exceed the height of the fabric softener storage part 120.

In other words, the levels of the liquid detergent and the fabric softener stored in the liquid detergent storage part 110 and the fabric softener storage part 120 are always kept lower than the height of the filter 300.

This improves the efficiency of the filter 300 to collect extraneous material.

The filter 300 may affect the flow efficiency of the liquid additives flowing from a front region of the main body 100 (where the liquid additives are supplied) toward a rear region of the filter 300 (where the nozzle part 130 is disposed.) To improve the flow efficiency, a plurality of grooves 330 may be formed at the lower end of the filter 300. Thus, part of the liquid additives may flow toward the nozzle part 130 through the grooves 330.

In the illustrated embodiment, a filter 300 is mounted inside each storage part 110 or 120. However, this implementation is merely exemplary. The efficiency of collecting extraneous material may be improved by mounting additional filters 300 in each storage part 110 or 120. This can further reduce clogging of the nozzle caused by extraneous material.

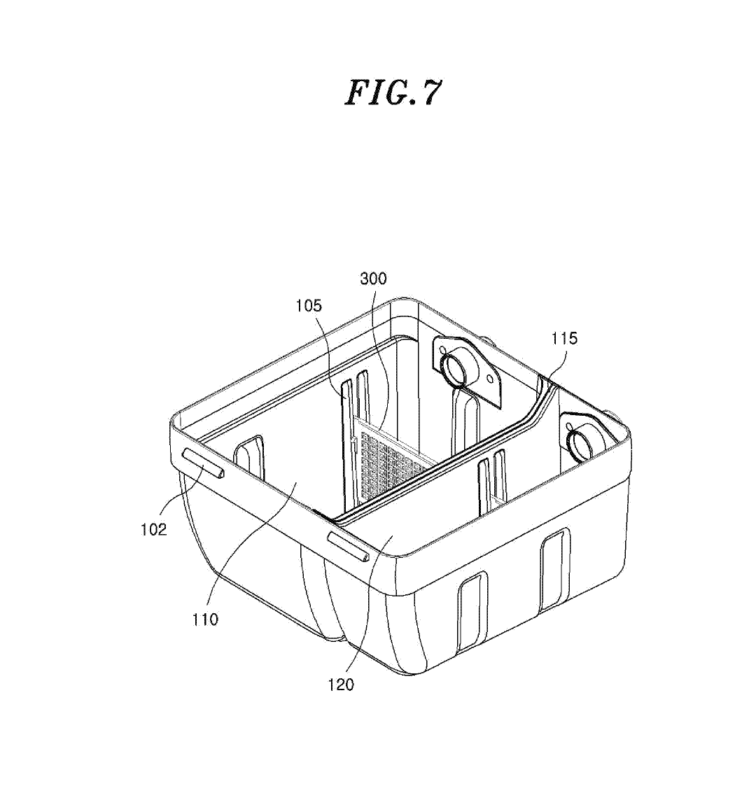

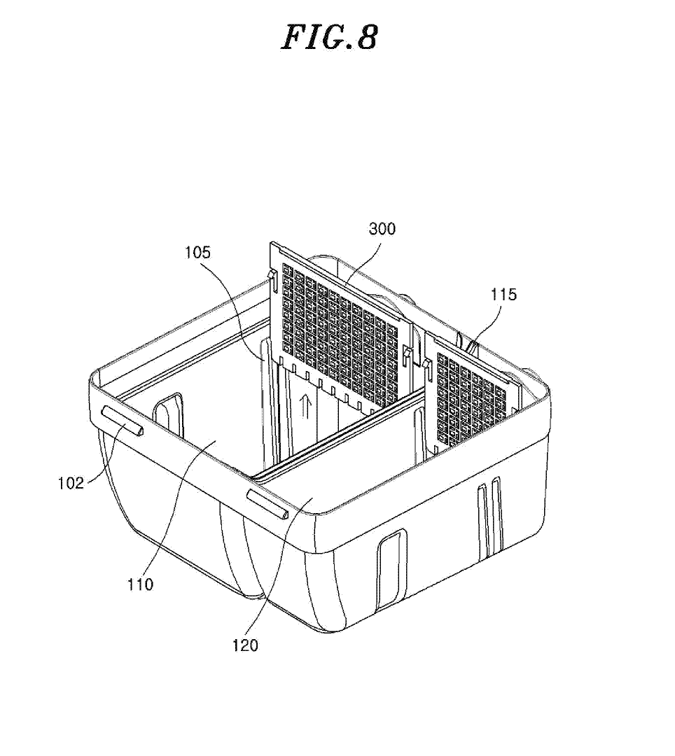

Hereinafter, the operation and effect of the liquid additive supply device 10 according to one embodiment of the present disclosure are described with reference to FIGS. 7 and 8.

FIG. 7 illustrates a state in which the filter is mounted inside the main body of the liquid additive supply device for a washing machine according to one embodiment of the present disclosure. FIG. 8 illustrates a state in which the filter is being pulled out from the main body of the liquid additive supply device for a washing machine according to one embodiment of the present disclosure.

Referring to FIGS. 7 and 8. To assemble, a user inserts the filter 300 into the guide ribs 105 of the main body 100 and then affixes the cover part 200 to cover the top of the main body 100. The user hold the knob groove 214 of the cover part 200 and place the main body 100 in the accommodation part 2 of the detergent dispenser 1. A user can add liquid additives in the main body 100 before affixing the cover part 200 to the main body 100 or after placing the main body 100 in the accommodation part 2.

To remove the filter, the user may hold the knob groove 214 to remove the main body 100 from the accommodation part 2. The cover part 200 is released from the main body 100. Thereafter, the filter 300 is removed from the guide ribs 105 of the main body 100. Thus, the user can remove the filter 300 from the guide ribs and clean up the extraneous materials accumulated on the filter as well as liquid additive residues stuck on the bottom surface of the main body 100.

Although exemplary embodiments of the present disclosure are described above with reference to the accompanying drawings, those skilled in the art will understand that the present disclosure may be implemented in various ways without changing the necessary features or the spirit of the present disclosure.

Therefore, it should be understood that the exemplary embodiments described above are not limiting, but only an example in all respects. The scope of the present disclosure is expressed by claims below, not the detailed description, and it should be construed that all changes and modifications achieved from the meanings and scope of claims and equivalent concepts are included in the scope of the present disclosure.

From the foregoing, it will be appreciated that various embodiments of the present disclosure have been described herein for purposes of illustration, and that various modifications may be made without departing from the scope and spirit of the present disclosure. The exemplary embodiments disclosed in the specification of the present disclosure do not limit the present disclosure. The scope of the present disclosure will be interpreted by the claims below, and it will be construed that all techniques within the scope equivalent thereto belong to the scope of the present disclosure.

What is claimed is:

1. A liquid additive supply device for a washing machine, the liquid additive supply device comprising:
a first storage part for storing a first liquid additive; and
a first filter disposed inside the first storage part and configured to filter extraneous material from the first liquid additive before the liquid additive is supplied for a washing cycle.

2. A liquid additive supply device of claim 1 further comprising: a second storage part for storing a second liquid additive; and
a second filter disposed inside the second liquid additive storage part and configured to filter extraneous material from the second liquid additive.

3. A liquid additive supply device of claim 2 further comprising:
a main body comprising the first storage part and the second storage part; and
a nozzle configured to transport the first additive and the second additive upward within the main body.

4. The liquid additive supply device of claim 3, wherein the main body comprises a pair of guide ribs formed on a sidewall of the main body and configured to guide movement of one of the first filter and the second filter.

5. The liquid additive supply device of claim 4, wherein a size of a gap between the pair of guided ribs increases from a bottom of the main body to a top of the main body.

6. The liquid additive supply device of claim 3, wherein each of the first filter and the second filter is positioned between a front region of the main body to which the first liquid additive and the second liquid additive are supplied and a rear region of the main body where the nozzle is disposed.

7. A liquid additive supply device for a washing machine, the liquid additive supply device comprising:
an accommodation part disposed in a detergent dispenser;
a main body removably accommodated within the accommodation part and configured to store a liquid additive to be supplied to the detergent dispenser; and
a filter removably mounted inside the main body and configured to filter extraneous material from the liquid additive.

8. The liquid additive supply device of claim 7 further comprising a pair of guide ribs configured to guide movement of the filter, wherein the pair of guided ribs are disposed on a sidewall of the main body and extend in a longitudinal direction of the main body.

9. The liquid additive supply device of claim 8, wherein a size of a gap between the pair of guide ribs increases from a bottom to a top of the main body.

10. The liquid additive supply device of claim 7, wherein the main body comprises a first storage part and a second storage part separate from each other.

11. The liquid additive supply device of claim 10 further comprising a nozzle configured to: draw liquid additives from the first storage part and the second storage part; and
carry the liquid additives upward within the main body.

12. The liquid additive supply device of claim 10, wherein the filter is disposed between a front region of the main body and a rear region of the main body where the nozzle part is disposed.

13. The liquid additive supply device of claim 7, wherein the filter comprises: a first locking tab protruding along a surface of the filter; and a second locking tab protruding from a surface of the filter, wherein the first locking tab and the second locking tab extend in perpendicular orientations.

14. The liquid additive supply device of claim 7, wherein a plurality of grooves is formed at a lower end of the filter.

15. The liquid additive supply device of claim 7 further comprising:
a cover part configured to selectively cover a top of the main body, and
wherein the cover part comprises:
a main cover comprising: a knob portion having a knob groove: and a detergent supply portion for supplying liquid additives;
a first hole formed in the detergent supply portion and configured to supply a first liquid additive to the detergent dispenser;
a second hole formed in the detergent supply portion of the main cover and configured to supply a second additive to the detergent dispenser; and
an auxiliary cover connected to the main cover and configured to control openings of first hole and the second hole.

16. A washing machine comprising:
a detergent dispenser comprising an accommodation part; and
a liquid additive supply device coupled to the detergent dispenser and comprising:
a main body removably accommodated within the accommodation part and configured to store a liquid additive to be supplied to the detergent dispenser; and
a filter removably mounted to an interior of the main body and configured to filter extraneous material from the liquid additive.

17. The washing machine of claim 16, wherein the liquid additive supply device comprises a pair of guide ribs configured to guide movement of the filter and extending in a vertical direction of the main body, wherein the pair of guided ribs are formed on a sidewall of the main body.

18. The washing machine of claim 17, wherein the main body comprises multiple compartments for storing liquid additives.

19. The washing machine of claim 18, wherein the liquid additive supply device further comprises a nozzle configured to draw liquid additives from the multiple compartments and carry the liquid additives upward within the main body.

20. The washing machine of claim 19, wherein the filter is disposed between a front region of the main body and a rear region of the main body, wherein the nozzle part is disposed in the rear region.
